(19) United States
(12) Patent Application Publication
(10) Pub. No.: US 2016/0286825 A1
(43) Pub. Date: Oct. 6, 2016

(54) METHOD OF MANUFACTURING PACKAGED STEAMED BUNS

(71) Applicant: Binshe ZHANG, Weinan City, Shaanxi (CN)

(72) Inventor: Binshe ZHANG, Weinan City, Shaanxi (CN)

(21) Appl. No.: 15/037,930

(22) PCT Filed: Nov. 19, 2014
(86) PCT No.: PCT/CN2014/091683

§ 371 Date: May 19, 2016

(30) Foreign Application Priority Data
Nov. 19, 2013 (CN) 201310587468.0

(51) Int. Cl. A21D 8/02; A21D 2/18

(52) U.S. Cl. CPC A21D 8/02; A21D 2/186

(57) ABSTRACT

A method for manufacturing packaged steamed buns, specifically including the following steps carried out continuously: preparing a leavener at room temperature indoor by fermenting a fermentation medium 4-6 times in succession to obtain the leavener; mixing the leavener; mixing the leavener and dough; mixing the dough; kneading the dough; shaping; proofing; Steaming at a steaming temperature of 97-100° C.; heating until the centers of the steamed buns reach a temperature of 97° C. or higher, then heating at a constant temperature for 30 minutes or more to obtain the steamed buns packaging for freshness, inspecting, observing, and storing the steamed buns.

### FIELD OF THE INVENTION

The present invention relates to the field of protein purification, and in particular to a method of manufacturing packaged steamed buns.

### BACKGROUND

Due to its convenience features, the packaged steamed buns are popular with people living in the rapid pace of life in modern society. The method of manufacturing packaged steamed buns can be roughly divided into three ways. The first way is to charge air into the packaging box to achieve the object of preservation, e.g., 1) The Chinese patent application (application No.: 20110187112) discloses a method of packaging and storing a packaged and mold-proofing steamed breads, and the treatment process includes steaming, freezing, packaging and replacement of air in the packaging box and sealing. The gas charged therein is the gas mixture of carbon dioxide and nitrogen mixed in certain ratio. The shelf life of the steamed buns is sixty days at room temperature in the first and fourth quarter and 80 days at temperature 0° C.-5° C.; 2) The Chinese patent application (application No.: 20110187112) discloses a method of packaging and storing the steamed buns products. The gas charged therein is food-grade carbon dioxide. The shelf life of the steamed buns is sixty days at room temperature in the first and fourth quarter and 90 days at temperature 0° C.-5° C. Although said method of packaging can achieve certain effect of preservation, it requires inflation equipment for charging air, which is time and energy-consuming and of high cost. The second way is to freeze the steamed buns or store them at low temperature. Generally, the steamed buns are frozen by quick-frozen technology and stored, transported and saled in frozen state (the centers of the steamed buns are at temperature below −18° C.). Even though such method can effectively preserve the steamed buns, the cost thereof far outweighs the preservation under room temperature. The third way is to add preservatives for achieving the object of preservation. Such method is obviously not preferred for healthy and safe food and the storage time is not long enough, generally one month and not longer than 2 months. The packaged steamed buns obtained by the above three ways have the longest term of preservation at room temperature for 60 days. The shelf life thereof is relative short.

In addition, in terms of steaming steamed buns, the most frequently adopted technology currently for fermentation is fermentation by dry yeast or yeast powder. After one-time kneading dough, shaping of dough is conducted subsequent to proofing for 60 minutes. Such process takes a short time. Some fermentation is carried out by using leavening dough and most of fermentation is conducted by using base. The steamed buns obtained via these methods of fermentation are poorly preserved and have a short shelf life.

### DESCRIPTION OF THE INVENTION

The object of the present invention is to provide a method of manufacturing packaged steamed buns overcoming the defects or shortage of the method of preserving the steamed buns by the prior art. The present method includes fermenting dough with a leavener obtained from 4-6 times of fermentation without adding any preservatives and replacing the air during packaging process. It is verified by test that the shelf life of the packaged steamed buns obtained by the method of the present invention can reach 90 days at room temperature.

To achieve the above object, the present application adopts the following technical solution for solving the technical problem concerned.

A method of manufacturing packaged steamed buns, comprising specifically the steps carried out in succession:

### Step 1 Preparing a Leavener

At room temperature, well mixing 6000 parts by weight of water, 725 parts by weight of leavener agent and 40 parts by weight of distiller's yeast so as to obtain a mixture, and then pouring into the mixture 840 parts by weight of fermentation medium for fermentation for 8-15 hours; and then fermenting 2-4 times in succession in the following steps: adding and mixing 1000 parts by weight of fermentation medium and fermenting for 3-9 hours ; adding 3500 parts by weight of fermentation medium and 50 parts by weight of distilled spirit, and well stirring and flattening the prepared mixture and putting it in a natural ventilation environment, and stirring it one time every 1-2 hours to obtain a leavener 2 days later;

### Step 2 Mixing the Leavener

Adding every part by weight of leavener obtained from Step 1 with 3 parts by weight of water to dissolve the leavener and then adding 3 parts by weight of flour into the dissolved leavener and well mixing the mixture and fermenting the mixture at 20° C. -45° C. for 3-8 hours.

### Step 3 Mixing the Leavener and Dough

Adding every 7 parts by weight of leavener obtained from Step 2 with 13 parts by weight of flour and 3.5-5.5 parts by weight of water and mixing them and shaping them into dough, wherein the temperature of the water is 20° C. -45° C.; and fermenting the obtained dough in fermentation tank at 20° C. -45° C. for 5-9 hours to obtain the leavening dough;

### Step 4 Mixing the Dough

Adding a part by weight of flour with 0.3-0.5 parts by weight of the leavening dough and 0.35-0.45 parts by weight of water and then mixing the dough;

### Step 5 Kneading the Dough

Dividing the mixed dough into pieces and kneading the pieces manually or by a dough kneading machine;

### Step 6 Shaping

Shaping the dough for steamed breads manually or by dough shaper according to the size and type of the steamed breads which may be further prepared into stuffed buns or steamed roll as desired;

### Step 7 Proofing

### Step 8 Steaming to Obtain the Steamed Breads

### Step 9 Packaging, Examining, Observing and Storing the Steamed Breads

Further, the method for the preparation of leavener agent is as follows: at room temperature, well mixing 6000 parts by weight of water, 725 parts by weight of dry yeast and 40 parts by weight of distiller's yeast, and then pouring into the mixture 840 parts by weight of fermentation medium for fermentation for 8-15 hours; fermenting for 3-9 hours after adding 1000 parts by weight of fermentation medium; fermenting for 3-9 hours after adding 1000 parts by weight of fermentation medium for the second time; fermenting for 3-9 hours after adding 1000 parts by weight of fermentation medium for the third time; adding 3500 parts by weight of fermentation medium and 50 parts by weight of distilled spirit simultaneously for the last time, and well stirring and flattening the prepared mixture and putting it in a natural ventilation environment, and stirring it one time every 1-2 hours to obtain a leavener 2 days later.

Further, the fermentation medium in Step 1 is wheat flour, corn flour, various starches or rice flour.

Further, the flour used in Step 4 is formulated by mixing wheat flour or coarse cereals in the form of flour or slice, or fruits and vegetables in the form of fragment, strip, slice with wheat flour; adding water or the mixture of water, fruits and vegetables sauce and juice when kneading the dough.

Further, said Step 7 comprises the proofing of the shaped dough for steamed breads, wherein the temperature of proofing is 30° C-45° C., humidity is 80-90, and time of proofing is 40 minutes to 90 minutes.

Further, said Step 7 comprises steaming at a temperature of 97° C. to 100° C. comprising steaming until the centers of the steamed breads reach a temperature of 97° C. or higher, then keeping steaming at the temperature for 30 minutes or more.

The advantages of the method of manufacturing packaged steamed buns of the present invention are as follows:

1. The preparation process for a leavener is unique. The leavener agent firstly is prepared by using dried yeast powder, distiller's yeast and wheat flour. Wheat flour or corn flour or various starches or rice flour are used as fermentation medium which are fermented for 4-6 times in succession to obtain a leavener at room temperature. The process of preparing a leavener retains the traditional technology for natural fermentation and combines with scientific test method for controlling the preparation parameters.

2. Prior to the steaming, three fermentation steps as mixing leavener, kneading the leavening dough, proofing are conducted so that the leavening dough for steamed buns is sufficiently fermented. The steamed buns are well-shaped and better-tasting.

3. The steamed buns are proofed and steamed in succession, and steamed until the centers of the steamed buns reach a temperature of 97° C. or higher, then heated at a constant temperature for 30 minutes or more and the temperature controlled by stages, which has the advantages of high utilization ratio of heat produced among different stages, low energy consumption and precise controlling of microorganism.

4. Packaging on line in a sterile environment, adding no preservatives to the ingredients, precise controlling, packaging while hot ensures the quality of final product and food safety; absence of base ensures the wholeness of nutritional components.

5. The fruits and vegetables and coarse cereals steamed buns can be prepared from coarse cereals and the vegetables and fruits in the form of juice, sauce, fragments, strip, slice, ensuring the balanced nutrition.

6. The steamed buns prepared by the method in the present invention does not need to be preserved in frozen state. It is verified by test that when the steamed buns are preserved at room temperature for 90 days, neither staphylococcus aureus or E. coli can be detected. The quantity of mould is within the national standard and is ready-to-eat. The buns warmed for more times have good taste and no obvious ageing of the buns are observed.

The present invention is further described in connection with the following embodiments.

### DETAILED DESCRIPTION OF EMBODIMENTS

The present invention relates to the following contents: studying the method of manufacturing packaged steamed buns directed against the short shelf life of the steamed buns disclosed by the prior art and come to the conclusion on the manufacturing process and technological parameter via theoretical analysis and a plurality of experiments. The specific experiment process is as follows:

### I. Selection of Fermentation Mode

The fermentation mode in the prior art has poor preservation effect and short shelf life. The inventor adjusts the experiments via a plurality of formulations to obtain the desired leavener for the steamed buns. When the steamed buns manufactured by using leavener for formentation is compared to the steamed buns which are manufactured by the prior art by using dry yeast, yeast flour or base for formentation, the steamed buns obtained by the present invention have the longest shelf life under the condition that steaming tools, steaming temperature and packaging technology are all the same.

### II. Determination of Times of Fermentation

The optimization experiments on fermentation times of leavener for leavener agent are carried out. If the number of times of fermentation is too few, the leavening dough, fermentation of the dough and quality of the final steamed buns will be affected; over-fermentation will result in thick acid taste of the steamed buns. Fermentations for four times, five times, six times, seven times, eight times and nine times are conducted respectively by applying suitable amount of leavener. The dough are proofed and steamed are conducted in a same steamer under the same condition after mixing leavener, mixing the leavening dough and mixing the dough. It is verified that the leavener with the its formentation for five times is superior to formentation for other times in terms of its activity, texture of the steamed buns and its flavor.

### III. Absence of Base

In the process of steaming the steamed buns, addition of base is to neutralize the acid taste produced by over fermentation. As the amount of base is determined by the proofing degree of the dough of which every batch is different, addition of standard amount is not applicable because it will lead to varied taste of the final product. In the meantime, addition of base will destroy vitamin B group in the flour, which is not scientific from the perspective of nutrition. However, base is not applied in the manufacturing process of the present invention. The steamed buns obtained in the present invention has a strong taste of wheat and fermentation and moderate degree of acidity because every production process including the preparation of leavener, mixing leavener, mixing leavening dough, fermentation of dough (i.e., proofing) is well controlled, preventing overfermentation and moderate degree of acidity is maintained and B vitamin groups is retained.

### IV. Determination of Steaming Temperature and Time

When the proofed dough is put into the steamer, the steam getting into the steamer shall be appropriate. If the steam is too excessive, air bubble is easy to occur on the steamed buns and the surface thereof does not look smooth and fine; while, if the steam is not sufficient, the shape of steamed buns are easy to be changed because a large amount of fermentation produced during the slow rising of temperature . After many tests, it is verified that the steamed buns will be the best in appearance; quality and flavor under the condition that the temperature in the steamer reaches 97° C.-100° C. after the steamed buns are put into the steamer for 9-10 minutes. By this standard, the air inlet valve shall be adjusted according to different steam pressure.

The steaming time is determined based on the standard that the microorganisms in the steamed buns are killed and the starch is completely gelatinized. Through many tests and determination of heat conduction of F value, it is determined that for the well-cooked steamed buns with 38%-39% in water content, 10 cm in diameter, 7 cm in height, it takes 40-45 minutes for the temperature of centers of the steamed buns reaches 97° C.-100° C. According to relevant materials, it will take 30 minutes to kill Bacillus spores at 100° C. Therefore, when the center of the steamed buns reaches a temperature of 97° C.-100° C. at a constant temperature for 30 minutes or more, the microorganisms in the steamed buns are killed and the starch is completely gelatinized.

The present invention is also illustrated by the following examples to verify the applicability of the present method. It shall be noted that the examples in the present invention are conducted according to the technical solution of the present invention. However, the scope of the present invention is not limited to the following examples.

### EXAMPLE 1

1. Preparing a leavener: At 16 o'clock on Oct. 2, 2013, and at room temperature 25° C., 6000 g water was added to a fermentation tank, 725 g leavener agent and 40 g distiller's yeast were then poured into the fermentation tank and stirred till dissolved, and 840 g wheat flour was poured into the mixture and well mixed; at 7 o'clock am. on Oct. 3, 2013 and at room temperature 21° C., 1000 g corn flour was added to the mixture and well mixed; at 10 o'clock am. on Oct. 3, 2013 and at room temperature 22° C., 1000 g corn flour was added to the mixture and well mixed; at 13 o'clock on Oct. 3, 2013 and at 26° C., 1000 g corn flour was added to the mixture and well mixed; at 16 o'clock on Oct. 3 and at room temperature 25° C., 3500 g corn flour and 50 g distilled spirit were added to the mixture simultaneously, and well stirred and the obtained mixture was flattened and put in a room with natural environment, fermented naturally and air dried, stirred one time every 1-2 hours to obtain a leavener 2 days later;

The process of preparing leavener agent is the same as the process of preparing a leavener, except that the starting material of the leavener agent is replaced by the dry yeast. The dry yeast is selected from Angel® dry yeast, and distiller's yeast is selected from BEE brand distiller's yeast produced by Suzhou Food and Oil Co., Ltd..

2. Mixing the leavener: 1.5 kilograms of water was added to every half kilograms of leavener obtained from Step 1 to dissolve the leavener and then 1.5 kilograms of flour was added and well mixed for fermentation for 4 hours at 35° C.

3. Mixing the leavener and dough: 6.5 kilograms of flour and 2.75 kilograms of water were added to every 3.5 kilograms of leavener obtained from Step 2 and shaped into dough, wherein the temperature of the water is 35° C.; and the obtained dough was fermented in fermentation tank at 35° C. for 7 hours to obtain the leavening dough.

4. Mixing the dough: 0.175 kilograms of leavening dough, 0.21 kilograms of water were added to every half kilograms of flour, and then the dough is mixed by dough mixing machine. The amount of water is adjusted according to the needs of the variety of sizes and types and the requirement on hardness of the dough to be used.

5. Kneading the dough: Dividing the mixed dough into different pieces and kneading the divided dough manually or by dough kneading machine to ensure that dough was smooth and did not contain air bubble.

6 Shaping: Shaping the dough for steamed buns manually or by machine and putting the shaped dough into the steamer after loaded on steaming tray.

7. Proofing; Pushing the steamer into the proving room for proofing at a temperature of 35° C., humidity was 80, proving time was 40 minutes; flowed wind was used to ensure uniform temperature.

8. Steaming: tunneltype steaming equipment was used for steaming at temperature 100° C., and heating until the centers of the steamed buns reached a temperature of 97° C. or high, then heating at a constant temperature for 30 minutes or more to obtain the steamed buns.

9. Packaging: Packaging and sealing the steamed buns in sterile environment, the sterile device used is disclosed in Chinese patent ZL201120416554.1(title: Cleaning and packaging device for thermally packaged wheat flour food), the packaging device used is disclosed in Chinese patent ZL200920033861.4 (title: Packaging machine for thermal packaging of the wheat flour food).

10. Examination: Examining whether the sealing of the package was qualified.

11. Observing: The packaged steamed buns were observed for 3 days at room temperature.

12. Storing: The qualified product was packaged and put into the finished product warehouse.

It was verified by test that when the steamed buns obtained from this example were preserved at room temperature for 90 days, no staphylococcus aureus, or E.coli had been detected. The quantity of mould was within the national standard. The buns were ready-to-eat and had good taste when warmed for many times and no obvious ageing of the buns were observed.

### EXAMPLE 2

1. Preparing a leavener: At room temperature 25° C., pouring 6000 g water into fermentation tank, and then pouring 725 g leavener agent and 40 g distiller's yeast into the tank and stirred till dissolved, and then pouring into the mixture 840 g wheat flour and well mixed for formentation for 8 hours; and then forementing the obtained mixture for two times in succession in the following steps: adding 1000 g wheat flour and well mixed for formentation for 9 hours; adding 3500 g wheat flour and adding 50 g distilled spirit simultaneouly, and well stirring and flattening the obtained mixture and putting it in a room with natural ventilation for natural fermentation and air drying and stirring it one time every 1 hour to obtain a leavener 2 days later.

The process of preparing leavener agent is the same as the process of preparing the leavener as describe above, except that the starting material of leavener agent is replaced by dry yeast. The dry yeast and distiller's yeast is the same as those in Example 1.

2. Mixing the leavener: Adding to every half kilograms of leavener obtained from Step 1 1.5 kilograms of water to dissolve the leavener and then adding 1.5 kilograms of dough and well mixed for fermentation for 8 hours at 20° C.

3. Mixing the leavener and dough: Adding to every 3.5 kilograms of leavener obtained from Step 2 6.5 kilograms of flour and 2.25 kilograms of water and shaping them into dough, wherein the temperature of the water is 20° C.; and fermenting the obtained dough in fermentation tank at 20° C. for 9 hours to obtain the leavening dough.

4. Mixing the dough: Adding to every half kilograms of flour with 0.15 kilograms of leavening dough, 0.225 kilograms of water, and then mixing the dough by dough mixing machine; adjusting the amount of water according to the needs of the variety of sizes and types and the requirement on hardness of the dough to be used.

5. Kneading the dough: Dividing the mixed dough into different pieces and kneading the divided dough manually or by dough kneading machine to ensure that dough is smooth and does not contain air bubble.

6 Shaping: Shaping the dough for steamed buns manually or by machine and putting the shaped dough into the steamer after loaded on steaming tray.

7. Proofing: Pushing the steamer into the proving room for proofing at a temperature of 45° C., humidity is 80, proving time is 60 minutes; flowed wind is used to ensure the uniform temperature.

8. Steaming: Adopting tunneltype steaming equipment for steaming at temperature 100° C., and heating until the centers of the steamed buns reach a temperature of 97° C. or high, then heating at a constant temperature for 35 minutes or more to obtain the steamed buns.

9. Packaging: Packaging and sealing the steamed buns in sterile environment, the sterile device used is disclosed in Chinese patent ZL201120416554.1(title: Cleaning and packaging device for thermally packaged wheat flour food), the packaging device used is disclosed in Chinese patent ZL200920033861.4 (title: Packaging machine for thermal packaging of the wheat flour food) .

10. Examination: Examining whether the sealing of the package is qualified.

11. Observing: The packaged steamed buns are observed for 3 days at room temperature.

12. Storing: The qualified product is packaged and put into the finished product warehouse.

It is verified by test that when the steamed buns obtained from the examples are preserved at room temperature for 90 days, no staphylococcus aureus, or E.coli has been detected. The quantity of mould is within the national standard. The buns are ready-to-eat and have good taste when warmed for many times and no obvious ageing of the buns are observed.

### EXAMPLE 3

1. Preparing a leavener: At room temperature 25° C., pouring 6000 g water into fermentation tank, and then pouring 725 g leavener agent and 40 g distiller's yeast into the tank and stirred till dissolved, and then pouring into the mixture 840 g wheat flour and well mixed for formentation for 8 hours; and then forementing the obtained mixture for four times in succession in the following steps: adding 1000 g wheat flour and well mixed for formentation for 3 hours; adding 3500 g wheat flour and adding 50 g distilled spirit simultaneously, and well stirring and flattening the obtained mixture and putting it in a room with natural ventilation for natural fermentation and air drying and stirring it one time every 2 hours to obtain a leavener 2 days later.

The process of preparing leavener agent is the same as the process of preparing the leavener as describe above, except that the starting material of leavener agent is replaced by dry yeast. The dry yeast and distiller's yeast is the same as those in Example 1.

2. Mixing the leavener: Adding to every half kilograms of leavener obtained from Step 1 1.5 kilograms of water to dissolve the leavener and then adding 1.5 kilograms of dough and well mixed for fermentation for 3 hours at 45° C.

3. Mixing the leavener and dough: Adding to every 3.5 kilograms of leavener obtained from Step 2 6.5 kilograms of flour and 2.25 kilograms of water and shaping them into dough, wherein the temperature of the water is 20° C.; and fermenting the obtained dough in fermentation tank at 45° C. for 5 hours to obtain the leavening dough.

4. Mixing the dough: Adding to every half kilograms of flour with 0.25 kilograms of leavening dough, 0.175 kilograms of water, and then mixing the dough by dough mixing machine; adjusting the amount of water according to the needs of the variety of sizes and types and the requirement on hardness of the dough to be used.

5. Kneading the dough: Dividing the mixed dough into different pieces and kneading the divided dough manually or by dough kneading machine to ensure that dough is smooth and does not contain air bubble.

6 Shaping: Shaping the dough for steamed buns manually or by machine and putting the shaped dough into the steamer after loaded on steaming tray.

7. Proofing: Pushing the steamer into the proving room for proofing at a temperature of 45° C., humidity is 80, proving time is 60 minutes; flowed wind is used to ensure the uniform temperature.

8. Steaming: Adopting tunneltype steaming equipment for steaming at temperature 100° C., and heating until the centers of the steamed buns reach a temperature of 97° C. or high, then heating at a constant temperature for 90 minutes or more to obtain the steamed buns.

9. Packaging: Packaging and sealing the steamed buns in sterile environment, the sterile device used is disclosed in Chinese patent ZL201120416554.1(title: Cleaning and packaging device for thermally packaged wheat flour food), the packaging device used is disclosed in Chinese patent ZL200920033861.4 (title: Packaging machine for thermal packaging of the wheat flour food) .

10. Examination: Examining whether the sealing of the package is qualified.

11. Observing: The packaged steamed buns are observed for 3 days at room temperature.

12. Storing: The qualified product is packaged and put into the finished product warehouse.

It is verified by test that when the steamed buns obtained from the examples are preserved at room temperature for 90 days, no staphylococcus aureus, or E.coli has been detected. The quantity of mould is within the national standard. The buns are ready-to-eat and have good taste when warmed for many times and no obvious ageing of the buns are observed.

1. A method of manufacturing packaged steamed buns, characterized in that it comprises the following steps:
Step 1 Preparing a leavener:
At room temperature, mixing 6000 parts by weight of water, 725 parts by weight of leavener agent and 40 parts by weight of distiller's yeast so as to obtain a mixture, and then pouring into the mixture 840 parts by weight of fermentation medium for fermentation for 8-15 hours; and then fermenting 2-4 times in succession in the following steps: adding and mixing 1000 parts by weight of fermentation medium and fermenting for 3-9 hours ; adding 3500 parts by weight of fermentation medium and 50 parts by weight of liquor, and well stirring and flattening the prepared mixture and putting it in a room with natural ventilation environment, and stirring it one time every 1-2 hours to obtain a leavener 2 days later;
Step 2 Mixing the leavener:
Adding every part by weight of leavener obtained from Step 1 with 3 parts by weight of water to dissolve the leavener and then adding 3 parts by weight of flour into the dissolved leavener and well mixing the mixture and fermenting the mixture at 20° C. -45° C. for 3-8 hours.
Step 3 Mixing the leavener and dough:
Adding every 7 parts by weight of leavener obtained from Step 2 with 13 parts by weight of flour and 3.5-5.5 parts by weight of water and mixing them and shaping them into dough, wherein the temperature of the water is 20° C. -45° C. ; and fermenting the obtained dough in fermentation tank at 20° C. -45° C. for 5-9 hours to obtain the leavening dough;
Step 4 Mixing the dough:
Adding a part by weight of flour with 0.3-0.5 parts by weight of the leavening dough and 0.35-0.45 parts by weight of water and then mixing the dough;
Step 5 Kneading the dough:
Dividing the mixed dough into pieces and kneading the pieces manually or by a dough kneading machine;
Step 6 Shaping:
Shaping the dough for steamed buns manually or by dough shaper according to the size and type of the steamed buns which may be further prepared into stuffed buns or steamed roll as desired;
Step 7 Proofing;
Step 8 Steaming to obtain the steamed buns;
Step 9 Packaging, examining, observing and storing the steamed buns.

2. A method of manufacturing packaged steamed buns according to claim 1, characterized in that the method for the preparation of leavener agent is as follows: At room temperature, well mixing 6000 parts by weight of water, 725 parts by weight of dry yeast and 40 parts by weight of distiller's yeast, and then pouring into the mixture 840 parts by weight of fermentation medium for fermentation for 8-15 hours;
fermenting for 3-9 hours after adding 1000 parts by weight of fermentation medium;
fermenting for 3-9 hours after adding 1000 parts by weight of fermentation medium for the second time; fermenting for 3-9 hours after adding 1000 parts by weight of fermentation medium for the third time; adding 3500 parts by weight of fermentation medium and 50 parts by weight of distilled spirit simultaneously for the last time, and well stirring and flattening the prepared mixture and putting it in a with natural ventilation environment, and stirring it one time every 1-2 hours to obtain a leavener 2 days later.

3. A method of manufacturing packaged steamed buns according to claim 1, characterized in that the fermentation medium in Step 1 is wheat flour, corn flour, various starches or rice flour.

4. A method of manufacturing packaged steamed buns according to claim 1, characterized in that the flour used in Step 4 is formulated by mixing wheat flour or coarse cereals in the form of flour or slice, or fruits and vegetables in the form of fragment, strip, slice with wheat flour; adding water or the mixture of water, fruits and vegetables sauce and juice when kneading the dough.

5. A method of manufacturing packaged steamed buns according to claim 1, characterized in that said Step 7 comprises proofing of the shaped dough for steamed buns, wherein the temperature of proofing is 30° C. −45° C., humidity is 80-90, and time of proofing is 40 minutes to 90 minutes.

6. A method of manufacturing packaged steamed buns according to claim 1, characterized in that said Step 7 comprises steaming at a temperature of 97° C. to 100° C. comprising steaming until the centers of the steamed buns reach a temperature of 97° C. or higher, then keeping steaming at a constant temperature for 30 minutes or more.
